(19) United States
(12) Patent Application Publication
(10) Pub. No.: US 2001/0052545 A1
(43) Pub. Date: Dec. 20, 2001

(54) Method and system for securing goods and services for purchase

(75) Inventor: Oleg Serebrennikov, Moscow (RU)

Correspondence Address: DARBY & DARBY, 805 THIRD AVENUE, 27TH FLR., NEW YORK, NY, 10022, US

(73) Assignee: ZAO MEDIALINGUA

(21) Appl. No.: 09/845,815

(22) Filed: Apr. 30, 2001

(30) Foreign Application Priority Data
Apr. 28, 2000 (RU) 2000110711
Apr. 28, 2000 (RU) 2000110712
Apr. 28, 2000 (RU) 2000110714

(51) Int. Cl. G06K 7/10

(52) U.S. Cl. 235/462.46

(57) ABSTRACT

A method and system for using a dynamically displayed bar code on a wireless device such as a cell phone or PDS, and a bar code reader to obtain a particular good and service, includes the steps of: (1) inputting a description of the good or service into the wireless device; (2) dynamically outputting a bar code corresponding to the description on the display screen of the wireless device; (3) positioning the display screen of the wireless device at a bar code reader; (4) scanning the bar code at the bar code reader; and (5) delivering the good and service in response to the scanning step. The wireless device includes location-identifying means whereby the product can be delivered to the location of the user. The system includes a database of prestored product descriptions and corresponding bar codes which is referenced by the wireless device.

### TECHNICAL FIELD

The present invention relates to wireless technology and, more particularly, to a system and method for securing goods and services at a particular physical location using wireless and bar code technology.

### BACKGROUND

Wireless technology has permeated society in recent years as evidenced by the proliferation of cellular telephones and other wireless informational devices, e.g., personal digital assistant (PDAs). Most wireless devices sold today include an LCD or other display screen of such resolution that text as well as graphics can be viewed thereon. It is known to use wireless devices to query remote databases accessible via a wireless network to obtain information, e.g., price and availability of goods like consumer products. Such functionality is realized using WAP-enabled browsers in conjunction with wireless content provider networks.

It is known that the location of an operational wireless device can be now be identified in real-time using the built-in functionality of long-range wireless carrier networks. Additionally, short-range location-identification is also known. As an example, Bluetooth® technology allows the short-range location of wireless devices to be determined with a greater precision than has heretofore been available. By knowing the location of a cellular telephone, the location of the user of the cellular phone can likewise be known at any particular instance of time.

The use of bar code technology has similarly increased dramatically over recent years. Bar codes and associated bar code readers are used in a plurality of applications geared toward inventory control and product identification. For example, bar codes are used to control, organize and efficiently carry out the daily delivery of thousands of parcels by national couriers, e.g., United Parcel Services® and Federal Express®.

Often times, a consumer finds himself in a situation in which he is unable to locate a particular product either because he cannot find the product in a large commercial outlet or because he is not certain of the identity of the product. Other times, a consumer must forego purchasing a good because he is not in an identifiable location such that delivery of the good to the user is not practicable or possible.

What is desired, therefore, and has heretofore been unavailable is a system and method for obtaining a product using a wireless device that is capable of accurately identifying both a particular product as well as the real-time location of the user wishing to obtain the product so that the product can be delivered to the user in an efficient manner.

### SUMMARY

In one aspect of the present invention, a system and method are provided for using a dynamically displayed bar code on a wireless device and a bar code reader to obtain a good or service at a particular physical location. The system and method follow the steps of: (1) inputting a product description of the good or service into a wireless device; (2) receiving a bar code at the wireless device corresponding to the description; (3) dynamically outputting the bar code on the display screen of the wireless device; (4) positioning the display screen of the wireless device at a first bar code reader; (5) scanning the bar code at the first bar code reader; and (6) delivering the good to a user of the wireless device. The wireless device includes location-identifying means whereby the product can be delivered to the location of the wireless device or to a location corresponding to the location of the first bar code reader. The system includes a database of prestored product descriptions and corresponding bar codes which is referenced by the wireless device in selecting a product for delivery.

In a further aspect of the invention, the database is updated using a second bar code reader, wherein the second bar code reader is used to scan a bar code printed on a certain product. The scanned product is associated with the user such that a user may later query the database to retrieve the scanned bar code when the user later desires to obtain the product in a commercial outlet.

In a yet further aspect of the invention, the method and system perform the additional steps of: (1) correlating the location of the user with the location of a particular commercial outlet; (2) querying a database of goods and services available at the particular commercial outlet for a match to the product description input at the wireless device; and (3) in the absence of a match, displaying a message on the wireless device indicating that the good or service is not available at the particular commercial outlet.

In another aspect of the invention, a method and system are provided that allows a user of a wireless device to obtain an advertised good or service at an identifiable location. The method and system perform the steps of: (1) scanning a bar code relating to a good or service that appears in, e.g., an advertisement of the good in a magazine, using a bar code reading means of a wireless device; (2) sending data corresponding to the scanned bar code to a remote computer; (3) processing the data as a request to purchase the good or service; (4) determining the location of the good or service; (5) determining the location of the user and the proximity of the good to the location of the user, wherein the location of the user is determined based on one of the location of the wireless device and the location of a wireless device locating means; and (6) delivering the good or service to the user at the determined location of the user.

### DESCRIPTION OF THE DRAWINGS

The above-discussed and other embodiments of the system and method of the present invention will be described in greater detail hereinafter with reference to the following figures wherein reference like reference numbers indicate the same or similar components:

FIG. 1 illustrates an embodiment of the system of the present invention which includes a wireless device connected to a wireless network, with an internetwork, a database and a bar code reader;

FIG. 2 is a flow chart describing the operation of an embodiment of the system and method of the present invention;

FIG. 3 illustrates a further embodiment of the system of the present method which includes a second bar code reader; and

FIG. 4 illustrates an embodiment of the system of the present invention which includes a wireless device having bar code reader as an integrated component.

### DESCRIPTION OF THE PREFERRED EMBODIMENT

The following description of the preferred and various other embodiments of the system and method of the present invention are illustrative only and are not meant to limit the scope of the invention which is defined solely by the claims which are recited at the end of this document. Thus, the discrete components, elements, systems and processes described herein are discussed solely for the purpose of enabling one skilled in the art to practice the claimed invention and are not intended to define the limitations of the claimed invention.

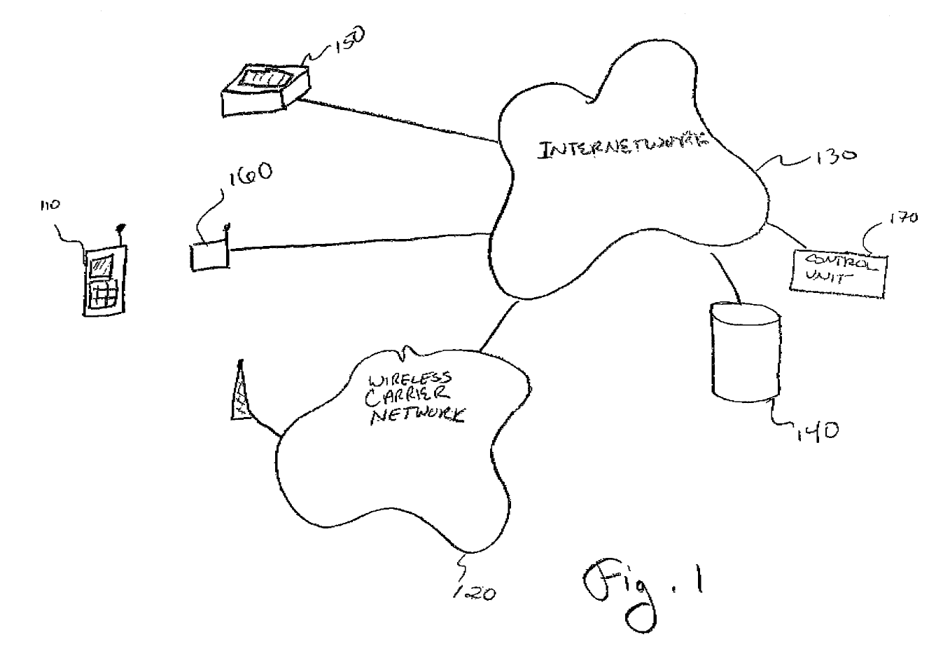

Turning to FIG. 1, an embodiment of a system of the present invention is illustrated. A wireless device 110 is represented by a cellular telephone. Wireless device 110 may alternately be a wireless PDA or any other known wireless device having an LCD or other display screen capable of displaying text and graphics. Wireless device 110 includes user input means, e.g., a keypad or writing stylus pad. As will be more fully explained hereinafter, a user of wireless device 110 utilizes the input means to enter a description of a good or service. Wireless device 110 then displays graphics representative of a bar code for that good or service that can be used to obtain the good or service.

Wireless device 110 communicates via wireless network 120 which may be any of the known wireless carrier networks, e.g., Verizon Wireless®, Cingular® or AT&T®. Wireless network 120 connects to internetwork 130 which preferably is the Internet but may be any known public or proprietary local or wide area network.

Internetwork 130 connects with a database 140. Database 140 contains a listing of product or service descriptions and respective corresponding bar codes. Intemetwork 130 also connects with a bar code reader 150 which is utilized to read a bar code present on the display of wireless device 110. Bar code reader 150 can be any of the various types of bar code readers known in the art and is preferably network-enabled allowing it to intelligently communicate with a control unit 170.

Internetwork 130 also connects to short-range location device 160 which is preferably a Bluetooth® sales point device. The specifications relating to Bluetooth® technology are publically available at the Bluetooth® SIG web site, bluetooth.com. Briefly, Bluetooth® wireless technology provides a low-power, short-range radio link between two or more electronic devices to thereby enable reliable transmissions between the devices using frequency hopping, digital packet transfer techniques. Using Bluetooth technology, short-range location device 160 determines the exact location of wireless device 120 to within a precision of mere inches.

Internetwork 130 also connects to a control unit 170 which is preferably a SunSPARC® or other server platform computer system that coordinates the operation and interaction of the various elements illustrated in FIG. 1 as described herein.

The particular manner and structure by which communications among the elements illustrated in FIG. 1 is accomplished is not critical to the present invention. Thus, one skilled in the art can appreciate that bar code reader 150 may be connected to wireless network 120 rather than internetwork 130. Alternately or additionally, database 140 may include one or more databases located together or remotely, each running respective networked database software in order to achieve speed and efficiency. Internetwork 130 may be the Internet or may alternately be a local area network providing connectivity for devices in a local environment.

The system of FIG. I is advantageously utilized by a user in, e.g., a department store, supermarket or other commercial outlet where many different products are offered in different locations throughout the store. The user utilizes his wireless device 110 to select a particular good that is believed to be available for sale at the commercial outlet and then receives, on the screen of the wireless device 110, a bar code corresponding to that designated good. The user thereafter scans the displayed bar code at bar code reader 150 which is located at a convenient location in the commercial outlet or elsewhere (e.g. at the user's home or hotel room). The good corresponding to the scanned bar code is then delivered to the user. In this manner, the user avoids the need to wander about the commercial outlet looking for the desired product and, thus, saves time and unnecessary effort.

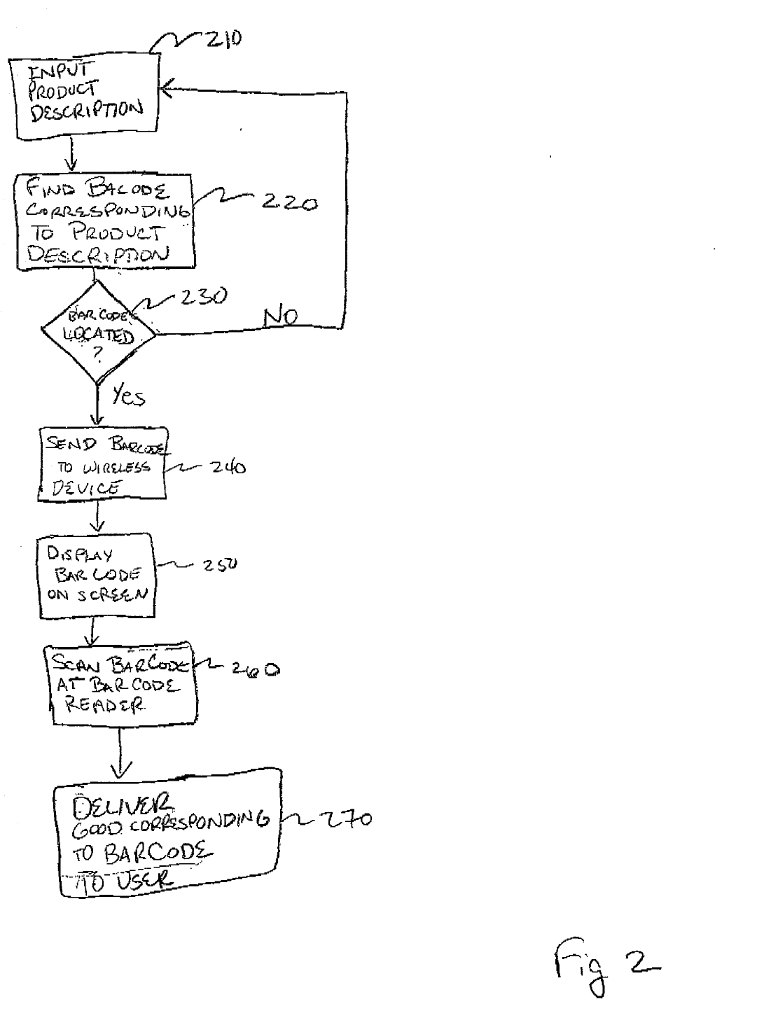

The operation of the system illustrated in FIG. 1 will now be described in greater detail with reference to the flow chart of FIG. 2.

At step 210, a user enters a description of a product or service into the user's wireless device 110. The description may be chosen from a menu of descriptions or may be entered directly by the user. In either event the product and service description corresponds to one of a multiplicity of descriptions that are preferably prestored in database 140.

As an example, in response to a user prompt at wireless device 110, database 140 and control unit 170 generate a menu that is delivered to, and presented on, the display of wireless device 110. The menu lists food categories, e.g., meats, milk, breads, soups, etc. Upon choosing “soups”, a submenu of selections is presented: “chicken, vegetable, and beef”. The user eventually (after navigating through any additional subcategories) settles upon a specific product description stored in database 140, e.g., “Acme Brand Canned Chicken Noodle Soup, 16 oz.”.

The descriptions of various goods and services from which the user selects are stored on database 140. Database 140 is preferably a networked server running known database software suites such as those designed by Oracle® and Microsoft®. Database 140 may be associated with the particular commercial outlet, e.g., supermarket where the user is presently situated. In such a case, database 140 contains product descriptions of goods that are presently in stock at the supermarket. Database 140 may be located on the premises of the supermarket (in which case internetwork 130 is understood to be a local area network) or may be remotely located and shared by a plurality of supermarkets (in which case internetwork 130 is understood to be the Internet, a virtual private network or a wide area network).

Rather than being associated with a particular commercial outlet, database 140 may alternately be associated with the user of wireless device 110 in which case database 140 contains descriptions of goods and services that have been prestored therein by the user. A further embodiment of the present invention which provides for updating such a user-specific database will be described in greater detail below.

In yet another alternate embodiment, the product descriptions relating to a plurality of goods and services are prestored by the user in the user's wireless device 110. In such a configuration, database 140 is understood to be resident on wireless device 110 itself and, thus, the need for a separate remote database 140 to maintain prestored descriptions as illustrated in FIG. 1 is not necessary. In such a configuration, where wireless device 110 is a cellular telephone, the cellular telephone is preprogrammed to include database functionality via custom-programmed application specific integrated chip (ASIC) design if the wireless device 110 is a PDA, database functionality is provided and implemented via known programming languages and development tools such as CodeWarrior® by Metrowerks® and the Palm OS™ Client Software Development Kit from Palm Computing®.

Alternately, the system includes multiple databases 140 of product descriptions in multiple locations, including that stored within wireless device 110. In this case, a user of wireless device 110 accesses both a user-specific as well as a commercial outlet-specific database 140.

In a still further embodiment, rather than selecting from a menu of product and service descriptions, the user enters a description manually using, e.g., a stylus and stylus handwriting recognition pad found on PDAs. Once the description is entered, control unit 170 matches the user-entered description with a corresponding one of the prestored description located in database 140.

Database 140 includes a table that correlates product and service descriptions with respective unique bar codes. At step 220, the system queries database 140 to find the bar code corresponding to the description entered at step 210. If at step 230, the system determines that there is no corresponding bar code in database 140, the system notifies the user by sending a message to wireless device 110 and then returns to step 210.

If, however, a corresponding bar code is located at step 220, the system proceeds to step 240 and sends bar code data to wireless device 110. At step 250, wireless device 110 displays the bar code on its display screen. Continuing with the present example, a bar code corresponding to a 16 oz. Can of “Acme Chicken Noodle Soup” is displayed on the screen of wireless device 110, perhaps together with other information.

At step 260, the user scans the bar code presently displayed on the screen of wireless device 110 at bar code reader 150. In response, a request is sent to, e.g., a stock room in the supermarket wherein stock room personnel is instructed to deliver the product corresponding to the bar code to the user's location. In response, the good or service, e.g., the “Acme Brand Canned Chicken Noodle Soup, 16 oz.” of the present example, is delivered to the user at the user's location. The user's location is based on either the location of bar code reader 150 (which is prestored and known by control unit 170) or the exact location of wireless device 110 as identified by location-identification unit 160.

Variations on the above-described embodiments may be realized. For example, if the system determines that the product or service which the user seeks is not available at the user's present location then the system identifies the next closest supermarket to the user's present location by querying a database describing the inventory of that supermarket to determine if the requested good or service can be obtained thereat. If the product or service is located there, the user is informed, via wireless device 110, to proceed to the next closest supermarket, or, alternately, personnel in the stock room of the other supermarket is instructed to deliver the desired good to the user at his present location.

Additionally, the system of FIG. 1 preferably includes payment and display means located proximate to bar code reader 150. The display means, e.g., a free-standing LCD display, guides a user through various steps of the process described above by presenting the user with instructions. The payment means, e.g., a magnetic strip credit card reader, allows the user to pay for the requested good or service. The display and payment means are preferably connected to internetwork 130 and controlled by control unit 170. Alternatively, payment can be authorized by the user directly from the wireless device 110 by providing payment and delivery information.

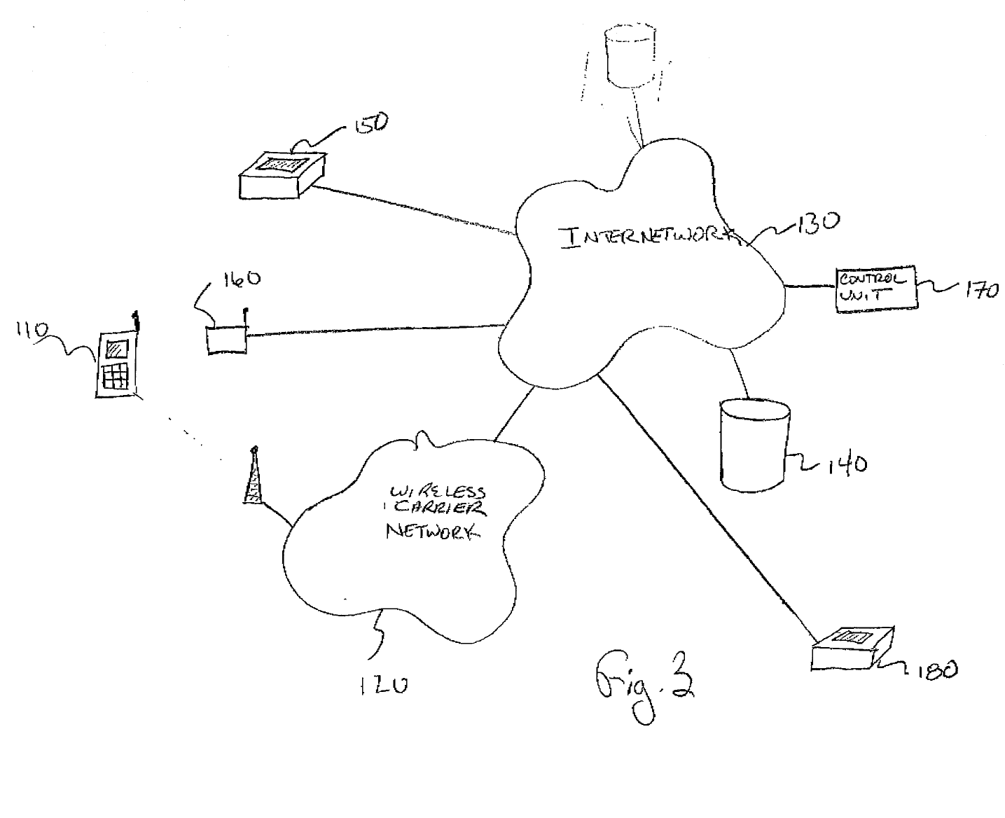

FIG. 3 illustrates a further embodiment of the present system wherein means for updating database 140 are provided. The system of FIG. 3 is similar to the system of FIG. 1 except that an additional bar code reader 180 is connected to internetwork 130.

Bar code reader 180 allows a user to update database 140 with bar codes relating to products that a user will frequently purchase in the future. Bar code reader 180 preferably Internet network-enabled. Bar code reader 180 is preferably placed in or around a user's refrigerator such that a user can scan a food product for future reference. As an example, if a user purchases a juice of a type and brand which he finds particularly satisfying, the user scans the bar code printed on the juice carton using bar code reader 180. Control unit 170 is programmed to update database 140 to include the bar code of the juice (if it is not already present in database 140) and further associates the bar code with the user. Accordingly, a user is assured that he will be able to access the bar code of, and thus obtain, the particular type and brand of juice during his next visit to the supermarket or when near a bar code reader 150.

The above described processes are accomplished by, and the system elements interoperate using, control unit 170 which, as described above, is preferably a microprocessor-based computer server capable of controlling various types of networked devices. Control unit 170 is programmed using any of the known programming languages in the art, including object oriented programming languages, e.g., C++. Control unit 170 may also utilize Internet-based object-oriented programming languages, e.g., Java, and is further capable of interacting with Bluetooth®-based components. The exact manner in which control unit 170 is programmed to accomplish the above-described processes is not critical and one skilled in the art will appreciate that various approaches may taken to implement the present invention without deviating from the scope of the invention.

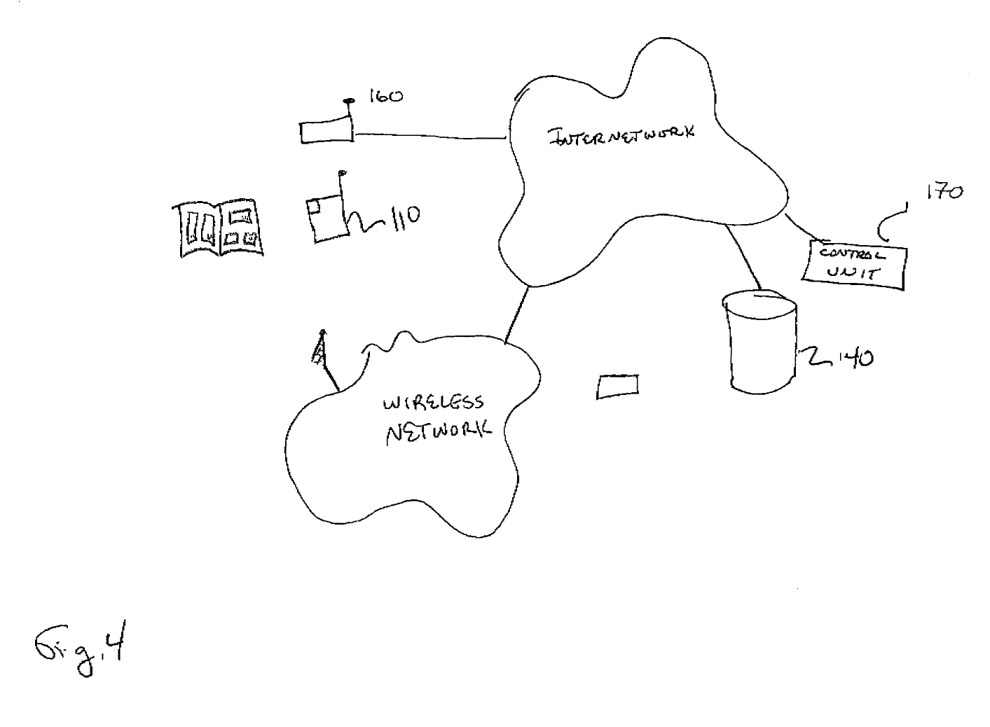

Another embodiment of the present invention is illustrated in FIG. 4. The system of FIG. 4 is similar to that of FIG. 1 except that: (1) it does not include bar code reader 150; and (2) wireless device 110 now includes a bar code reader as a physically integrated component. Wireless device 110 is used to read bar codes on, e.g., a product, advertisement or computer screen. Upon scanning the bar code, wireless device 110 communicates with control unit 170 which identifies an appropriate database 140 for querying. For example, the related bar code may be a database of goods that the control unit identifies as being in close proximity of wireless device 110.

As in the system of FIG. 1, database 140 of FIG. 4 contains a table of bar codes and corresponding goods and service descriptions. Database 140 matches the bar code scanned by wireless device 110 with its corresponding description. Control unit 170 then directs appropriate personnel to deliver the product or service relating to the scanned bar code to the user.

As in the case of the system of FIG. 1, many variations of the system configuration of FIG. 4 may be realized. For example, communications between wireless device 110 and control unit 170 may be achieved using wireless network 120 and internetwork 130 or, alternately, by utilizing only internetwork 130 via sales point 160.

As an example of the later case, multiple Bluetooth® sales points 160 are located throughout a hotel. Each guest room is provided with a menu listing room service items and other services with accompanying respective bar codes. A guest with a Bluetooth-enabled wireless device 110, selects a particular menu item using wireless device 110 by scanning the bar code associated with the item or service. Wireless device 110 communicates the scanned bar code selection to sales point 160 and then onto database 140 which finds the corresponding item or service in its records. Control unit 170 then sends the request to appropriate hotel personnel who fulfill the request by delivering the requested good or service to the user. The user's location is preferably identified via sales point 160.

The above-described embodiments of the system and method of the present invention are illustrative and one skilled in the art will realize that many variations may be made to the above without departing from the scope of the claimed invention.

I claim:

1. A method for using a dynamically displayed bar code and a bar code reader to obtain one of a good and service, comprising the steps of:
inputting a description of said one of the good and service into a wireless device;
dynamically outputting a bar code corresponding to the description on the display screen of the wireless device;
positioning the display screen of the wireless device at a first bar code reader;
scanning the bar code at the first bar code reader; and
delivering one of the good and service in response to the scanning step.

2. The method of claim 1, wherein said wireless device includes location-identifying means whereby one of said good and service can be delivered to the location of the wireless device.

3. The method of claim 1, wherein one of said good and service is delivered at a location corresponding to the location of said first bar code reader.

4. The method of claim 1, wherein the inputting step includes one of the steps of:
choosing the description from a plurality of pre-stored descriptions; and
manually entering the description corresponding to one of a plurality of pre-stored descriptions using alphanumeric data input means of the wireless device.

5. The method of claim 4, wherein the plurality of pre-stored descriptions are stored in one of the wireless device and a remote database accessible by the wireless device.

6. The method of claim 4, wherein each of said plurality of descriptions is correlated to a unique bar code.

7. The method of claim 6, including the additional step of dynamically updating one of said wireless device and said remote database to add a bar code, said updating step utilizing one of said wireless device and a second bar code reader as an input device, wherein said second bar code reader is used to scan said bar code printed on a product.

8. The method of claim 7, wherein the bar code of claim 6 is associated with said user.

9. The method of claim 7, wherein the second bar code reader is connectable to one of said wireless device and the remote database by way of an Internet connection.

10. The method of claim 7, wherein the second bar code reader is located in a user's house.

11. The method of claim 7, wherein the second bar code reader is located proximate to a refrigerator.

12. The method of claim 1, including the additional steps of:
determining the location of said wireless device;
correlating said location with the location of a particular commercial outlet;
querying a database of goods and services available at said particular commercial outlet for a match to the description input at the wireless device; and
in the absence of a match, displaying a message on said wireless device indicating that one of said good and service is not available at said particular commercial outlet.

13. The method of claim 12, wherein said location is one of the location of said wireless device, and the location of said first bar code reader.

14. The method of claim 12, including the additional steps of:
querying a database to determine the identification of one or more other commercial outlets where the one of said good or service corresponding to said description can be found;
determining the location of said one or more other commercial outlets; and
providing the name and location of said one or more different commercial outlets where one of said good and service can be found to said user.

15. A system for obtaining a good or service in response to a user's request, comprising:
a user input permitting input of a description of one of said good and service into a wireless device;
a receiver configurable to provide a bar code to the wireless device corresponding to the description;
a display on the wireless device having a resolution sufficient to display the bar code at the wireless device;
a scanner;
means permitting the location of said user to be determined;
a database containing a plurality of descriptions and data concerning which one of said good and service is available at said location; and
means for securing the delivery of the good or service to said user.

16. A method for a user of a wireless device to obtain a physical good or service at an identifiable location, comprising the steps of:
scanning a bar code relating to one of a physical good and service using bar code reading means of a wireless device;
sending data corresponding to said scanned bar code to a remote computer;
processing said data as a request to purchase one of said physical good and service;
determining the location of one of said physical good and service;
determining the location of the user and the proximity of one of the physical good and service to the location of the user, wherein the location of the user is determined based on one of the location of the wireless device and the location of a wireless device locating means; and
delivering one of said physical good and service to the user at the determined location of the user.

17. The method of claim 16, wherein said bar code is included as part of a description of said good and service.

18. The method of claim 17, wherein said description is included as part of an advertisement of said good and service.

19. Means for a user of a wireless device to obtain one of a good and service, comprising:
means for scanning a bar code relating to one of a good and service using a wireless device;
means for sending data corresponding to said scanned bar code to a remote computer;
means for determining the location of the user;
means for processing said data at said remote computer as a request to purchase one of said good and service; and
means for securing delivery of one of said good and service to the location of the user, wherein the location of the user is determined based on one of the location of the wireless device and the location of a wireless device locating means.
